(19) United States
(12) Patent Application Publication
(10) Pub. No.: US 2017/0312979 A1
(43) Pub. Date: Nov. 2, 2017

(54) METHOD FOR FORMING CONTAINERS WITH MULTIPLE WALLS

(71) Applicant: SIDEL PARTICIPATIONS, OCTEVILLE-SUR-MER (FR)

(72) Inventors: David ANDRIEUX, OCTEVILLE-SUR-MER (FR); Sebastien HOMONT, OCTEVILLE-SUR-MER (FR)

(21) Appl. No.: 15/499,987

(22) Filed: Apr. 28, 2017

(30) Foreign Application Priority Data
Apr. 28, 2016 (FR) 1653804

(51) Int. Cl. B29C 49/78; B29C 49/12; B29K 105/00; B29L 31/00

(52) U.S. Cl. CPC B29C 49/78; B29C 49/12; B29K 2105/258; B29C 2949/78386; B29C 2949/78025; B29L 2031/712; B29C 2949/78848

(57) ABSTRACT

Disclosed is a for forming a container with multiple walls by blow molding or stretch blow molding of a preform, including a blow-molding phase followed by a degassing phase, beginning at a moment, of the formed container, to bring t:s pressure back to the ambient pressure. The method also includes: a continuous measurement of the pressure prevailing in the neck during the degassing phase; the determination of the length of time that has elapsed between the beginning of the degassing and the attaining of a reference pressure in the neck; the comparison of the length of time that has elapsed with a theoretical length of time that is necessary so that the reference pressure is attained in the neck; and maintaining the locking of the mold if the length of time that has elapsed is less than the theoretical length of time.

The invention relates to the manufacturing of containers with multiple walls by blow molding preforms.

A container with multiple walls is a container that comprises at least two walls, namely a relatively rigid outer wall and a flexible inner wall that can be made of the same material but are generally made of different materials. The outer wall can thus be made of polyethylene terephthalate (PET), while the inner wall can be made of polypropylene (PP).

A first type of known container with multiple walls is the type known under the name of multilayer container. Such a container comprises at least two walls, one, the outer wall, imparting rigidity to the whole, and another, the inner wall, or else an outer wall, an inner wall, and at least one intermediate wall between the outer wall and the inner wall. The inner wall and, if necessary, the intermediate wall or walls have the role of optimizing the barrier properties to certain gases or components of the container contents when the outer wall cannot perform this function by itself. In this type of container, two adjacent walls are tightly attached to one another.

A second type of known container comprises only two walls. It is ordinarily used in storage (high-capacity) and the distribution of pressurized liquids (typically beer, lemonade). The contents (liquid) are stored in the space defined by the inner wall of the container. A pressurized gas (for example, air) is injected through an opening formed in the outer wall in a gap that forms a chamber made between the two walls, for compressing the inner wall and thus forcing the liquid to exit from the container. This type of container is used with, for example, the draft-beer tapping machines (or pumps) in bars.

One example of a container of this second type is described in the U.S. patent application US 2015/0108077 (Dispensing Technologies B.V.).

A container with multiple walls is in general manufactured by blow molding or stretch blow molding of a hot preform (i.e., a preform whose walls, except for its neck, are above the glass transition temperature of their constituent material) in a mold bearing the impression of the container. The preform has a body of essentially cylindrical shape that extends along a main axis, a bottom having an essentially hemispherical shape, which closes the body at a first end of the former, and an open neck that extends to an end that is opposite to the first.

A preform that is intended for the manufacture of a container with multiple walls comprises the same number of walls as the container, namely at least two walls that are adjacent to one another, with one, the outer wall, imparting rigidity to the whole, and an inner wall or else an outer wall, an inner wall, and at least one intermediate wall between the outer wall and the inner wall.

The preform can be produced by multi-material injection of the walls (in particular by co-injection). This is the case in particular for the preforms that are intended for multilayer containers where two adjacent walls are tightly attached to one another.

For the containers with two walls of the type of the one that is described in the U.S. patent application US 2015/0108077, the preform can be produced by performing a method that prevents two walls from adhering to one another, either by co-injection or by independent injection of the outer wall and the inner wall, and then by a subsequent assembly of these two parts. Regardless of the manufacturing mode (multi-material co-injection or subsequent assembly) of the preform that is intended for containers of this type, a step for tight attachment of an outside annular peripheral zone of the inner wall and an inside annular peripheral zone of the outer wall under the neck is implemented so as to constitute a sealing in this annular zone.

In all cases, for the containers with two walls of the type of the one described in the U.S. patent application US 2015/0108077, the outer wall of the perform is provided upon its manufacture with the above-mentioned opening that is on the finished container and through which the pressurized gas is injected that is used to compress the inner wall to force the liquid to exit from the container.

During the manufacture, by blow molding multilayer containers, the successive walls are to remain flattened against one another permanently.

In the case of containers with two walls, in which a pressurized gas (for example, air) is to be injected into the gap that exists between the two walls, during blow molding, the walls remain flattened against one another when the container is formed correctly. In other words, the outer face of the inner wall will conform to the shape of the inner face of the outer wall without, however, the walls adhering to one another, except for a peripheral zone, located under the neck of the preform, where the two walls are attached in an airtight way to one another. Thus, when the container is formed, a gap is made between the two walls into which a gas can be injected through the opening made in the outer wall so as to form a chamber. As will be explained later, the gap, therefore the chamber, remains empty when the container is formed correctly.

The mold for manufacture of a container with multiple walls ordinarily comprises two half-molds that can move relative to one another (either articulated or movable) between an open position, in which the half-molds are separated from one another, and a closed position, in which the half-molds are brought together and then locked to one another. The half-molds determine the impression of the body of the container and sometimes also that of the bottom.

However, in many cases, the mold also comprises a mold bottom that can move axially relative to the half-molds. In the open position, the mold bottom is removed axially from the half-molds; in the closed position, it is brought closer axially and locked relative to the half-molds. The half-molds determine the impression of the body of the container, and the mold bottom determines that of the bottom of the container; its presence facilitates the demolding of the containers that have bottoms of complex shape.

After installation of the previously-heated preform in the mold, the former is locked in the closed position. A gas under high pressure (typically air) is injected into the preform through the opening that is made in its neck, which causes the simultaneous deformation of the inner wall (by inflation of the former under the pressure that is exerted directly by the gas) and the outer wall (and, if necessary, intermediate walls) under the thrust exerted by the inner wall, until the outer wall is flattened against the mold. The high-pressure blow molding (the phase during which the gas is injected) can be preceded by a pre-blow molding and/or accompanied by a stretching using an elongation rod that drops into the volume of the preform that is delimited by the inner wall. A finished container is therefore produced in which the walls are flattened against one another. Then, degassing of the formed container is initiated, which in this case consists in degassing the volume delimited by the inner wall, accompanied by the exiting, in this case by lifting, of the rod. After a predetermined length of time, which is presumed necessary for equalizing pressure inside and outside of the container, the mold is opened, and the container is evacuated from the mold.

In the description below, the term “blow molding” will be used interchangeably to designate a technology for transforming a preform into a container that implements a high-pressure blow-molding process, optionally preceded by a pre-blow molding and accompanied or not by a stretching, unless a distinction is necessary, in which case the former will be carried out.

As long as the preform does not have any defects, there is no risk to this procedure: at the end of the manufacture, the walls remain effectively flattened against one another. However, sometimes the inner wall is affected by a defect, such as a fissure, a crack, a hole. Such a defect can originate from the manufacture of the preform or from poor handling during its storage or its transport. Regardless, the presence of a defect in the preform may have devastating consequences: cases of damage, and even complete destruction, of the mold during its opening are indeed deplored.

Analysis shows that such a phenomenon of damage or destruction is the consequence of the fact that, during blow molding, pressurized gas sometimes comes to be introduced between the inner wall and the outer wall (or the intermediate wall that adjoins the inner wall in the case of multilayer containers) by passing through the hole (or the fissure or the crack) that, as the case may be, gets bigger. Delamination of the walls, even if the walls are intended to adhere to one another, as is the case of multilayer containers, and the creation of a chamber outside of the inner wall then get under way.

Also, instead of remaining flattened against one another, the walls pull back, in such a way that a significant volume of pressurized gas comes into the chamber that is thus created.

This gas may or may not be totally evacuated during the time normally allotted for degassing through the hole (or the fissure or the crack), be it multilayer containers or two-walled containers; likewise, it no longer manages to escape through the opening made in the outer walls of the containers that are provided with such an opening.

At the end of the length of time provided for the degassing, a significant volume of pressurized gas is therefore present, trapped between two walls in such a way that an opening of the mold under these conditions causes a sudden expansion of the gas that is thus trapped and creates a shock wave that has the consequence of the above-cited damage or destruction, with significant risks for the operators or the individuals who are close to the manufacturing machine. It is also advisable to note that when the forming is done by stretch blow molding, the introduction of gas between two walls can furthermore cause a tightening of the inner wall on the rod that prevents its removal and that adds to the damage.

To avert this danger to the facility and to personnel, an attempt has first been made to reduce the risks of defects in the preforms. However, taking into account production rates, even by reducing the probability of defects, the risk of damage or destruction remains high: in this case, one case every ten days of production.

A first objective is to reduce the risk of destruction (or serious damage) of a mold because of a defect that affects a preform with multiple walls, by acting directly on the process for manufacturing containers.

By so doing, a second objective is to preserve the integrity of the facility and the personnel.

For this purpose, a method for forming a container by blow molding starting from a preform with multiple walls made of plastic material is proposed, with this method comprising:
An operation for installing the preform in a mold bearing the impression of the container, with this mold comprising at least two half-molds that can a closed position in which the half-molds are assembled;
An operation for locking half-molds in the closed position;
A blow-molding phase that consists in linking the interior of the preform to a pressurized gas source for a predetermined length of time for forming the container, by applying at least a blow-molding pressure;
A degassing phase, beginning at a degassing start time and consisting in the linking of the interior volume of the container thus formed, through the opening made in its neck, to an environment at ambient pressure so as to bring the pressure in the container back to the ambient pressure;
A continuous measurement of the pressure prevailing in the area of the neck during the degassing phase;
The determination of the length of time that has elapsed between the beginning of the degassing and achieving a reference pressure in the area of the neck;
The comparison of the length of time that has elapsed with a theoretical length of time starting from which the pressure in the area of the neck in theory reaches the reference pressure;
Maintaining the locking of the mold if the length of time that has elapsed is less than the theoretical length of time.

“Measurement of pressure in the area of the neck” is defined as a measurement of the pressure in the environment that contains the neck, so that the measurement is not disrupted by a possible deformation of the inner wall: thus, it can be a measurement of the pressure that prevails in the blow-molding nozzle (which measurement proves to be the easiest to implement) or else a measurement with a probe that is inserted into the opening of the neck (which would require a slightly more complex apparatus).

In this way, the damage, and even the destruction, of the mold, which would happen if premature unlocking were carried out, is prevented. Actually, the pressure that is measured is that of the air that is contained in the inner cavity, in other words, the cavity that is determined by the interior of the inner wall. Two correctly formed containers, i.e., whose inner walls are intact, will require essentially the same length of time of degassing between the beginning of the degassing and attaining the reference pressure.

In contrast, if the inner wall of a container has deteriorated and a significant volume of gas is introduced into the gap made between two walls, causing the formation of a chamber between these two walls, the blow-molding air will be distributed between the inner cavity, which will contain much less air than that of a container that is correctly formed, and the chamber. Consequently, the inner cavity, containing less air, will degas more quickly, and the reference pressure will be attained more quickly.

Thus, by measuring an elapsed length of time of at least a portion of the degassing of the inner cavity, it is possible to anticipate the occurrence of a problem: the measurement of a length of time that is shorter than a theoretical length of time for decreasing the blow-molding pressure to the reference pressure very probably means that there is a problem. Both the facility and the personnel are thus protected.

According to other characteristics:
The reference pressure is ambient pressure;
The reference pressure is between the blow-molding pressure and the ambient pressure;
The reference pressure is a pressure, determined in a theoretical way, starting from which it is possible to open the mold without a risk of deterioration of the latter.

The following additional operations can be provided if the length of time that has elapsed is less than the theoretical length of time:
An alert signal will be generated.
An emergency shutdown of the container forming unit is brought about;
The maintaining of the locking of the mold is ensured for a predetermined length of time, advantageously greater than or equal to 30 seconds, and, for example, on the order of one minute;
At the end of the length of the time, the unlocking of the mold;
The container comprising an inner wall and an outer wall, with the latter being provided with an opening for linking to the outside, if the length of time that has elapsed is less than the theoretical length of time, the pressure at the opening is measured, and when the pressure at the opening reaches the reference pressure, an order for unlocking the mold is given;
The container comprising an inner wall and an outer wall, with the latter being provided with an opening for linking to the outside, if the length of time that has elapsed is shorter than the theoretical length of time, the flow rate of the gas exiting from the opening is measured, and when this flow rate has become zero, an order for unlocking the mold is given.

Other objects and advantages of the invention will become evident from the description of an embodiment, given below with reference to the accompanying drawings in which:

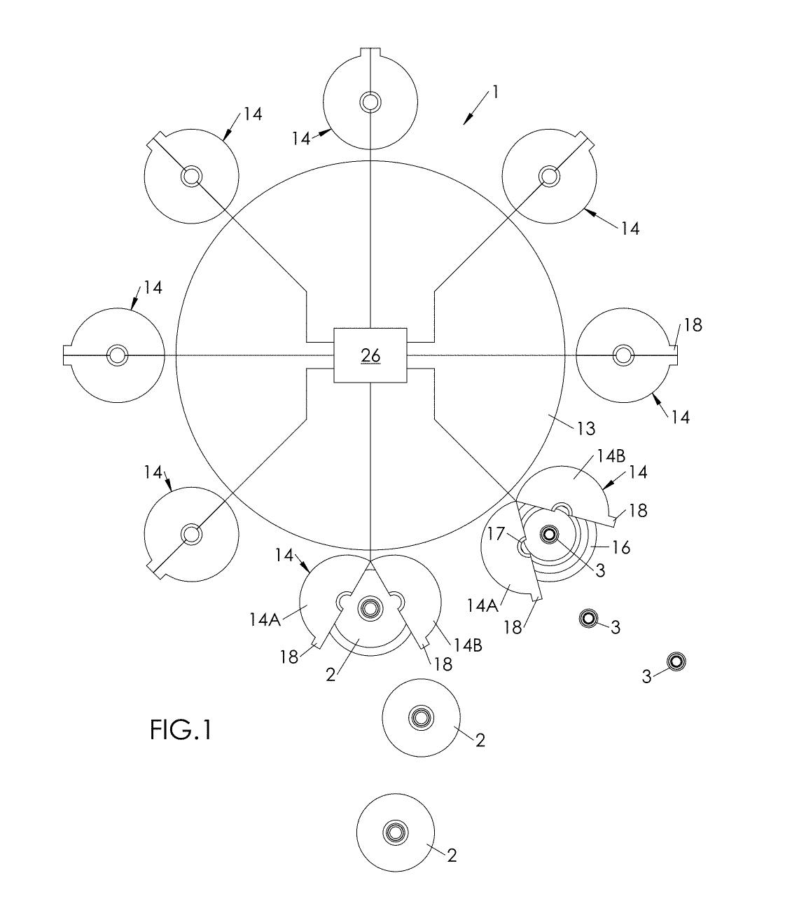

FIG. 1 is a diagrammatic top view of a container forming unit;

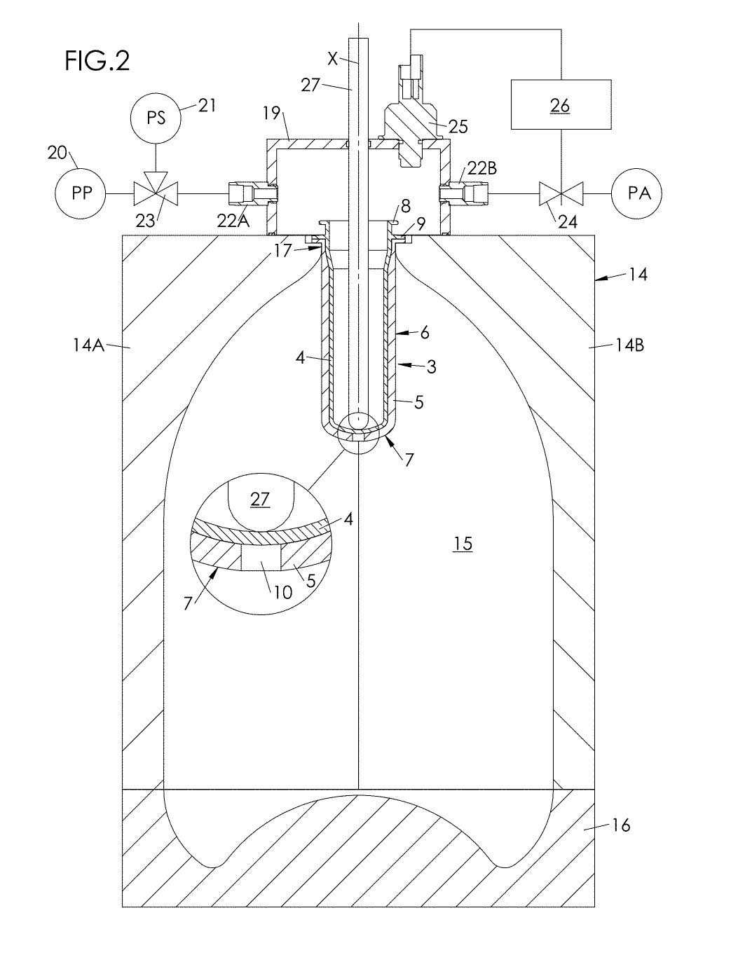

FIG. 2 is a diagrammatic cutaway view that shows a mold in which a preform with multiple walls is positioned;

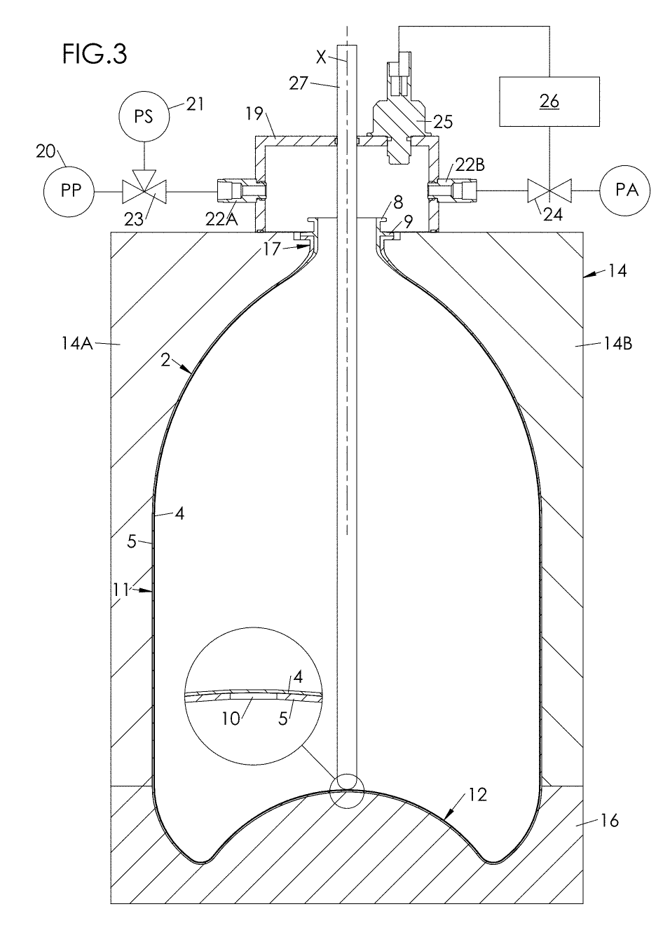

FIG. 3 is a view that is similar to FIG. 2, showing a container that is correctly formed in the mold;

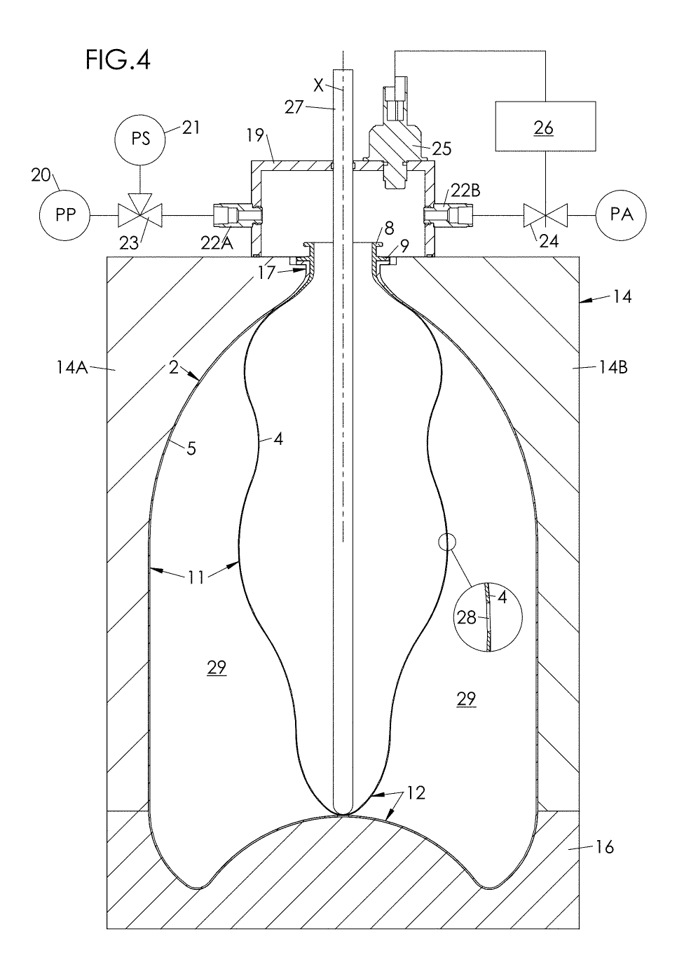

FIG. 4 is a view that is similar to FIG. 3, showing a container that is poorly formed because of a defect that has affected the preform;

FIG. 5 is a diagram that illustrates different steps of the method for manufacturing the container;

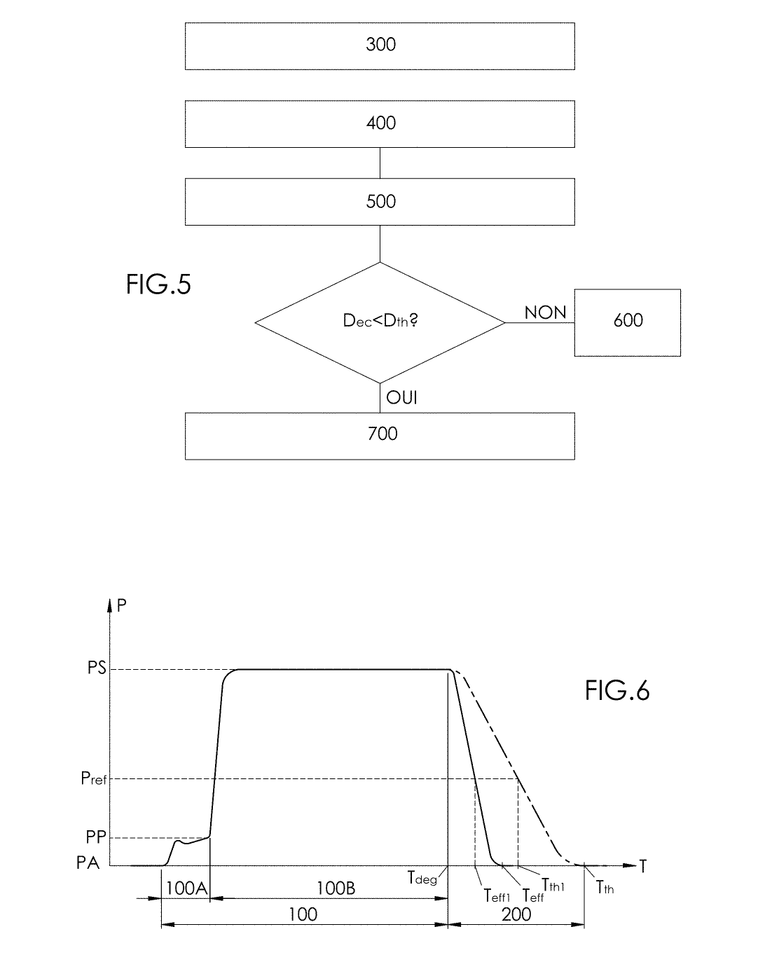

FIG. 6 is a diagram that illustrates the pressure variations during the forming of the volume that is delimited by the inner wall of a normal container and of a defective container, as a function of time.

FIG. 1 shows a unit 1 for forming containers 2 by blow molding or stretch blow molding starting from preforms 3 with multiple walls made of plastic material.

The expression “multiple walls” means that the preform 3 and therefore the container 2 comprise at least two walls, namely an inner wall 4 and an outer wall 5 that are separate and that can be made using two different materials. Between these two walls, it is possible to find one or more intermediate walls, as is the case in multilayer containers.

In the case of containers with two walls, of the type of the one described in the U.S. patent application US 2015/0108077, the outer wall 5, intended to form a relatively rigid casing of the container 2, is advantageously made using a polyester, for example polyethylene terephthalate (PET), while the inner wall 4, intended to form a relatively more flexible inner packet of the container 2, is made using, for example, a polyolefin, for example, polypropylene (PP).

For the sake of convenience, the same numerical references for designating the inner wall 4 (or the outer wall 5) in the preform 3 and in the container 2 are used below.

The preform 3 comprises a body 6 of essentially cylindrical shape, which extends along a main axis X, a bottom 7 of essentially hemispherical shape that closes the body 6 at a lower end of the former, and an open neck 8 that extends at an upper end of the body 6, opposite to the bottom 7. The neck 8 is separated from the body 6 by a collar 9 that makes it possible to ensure the lift of the preform 3, in particular during its transport and during the forming of the container 2.

The preform 3 can be produced by multi-material injection of the walls, for example by co-injection or by sequential multilayer injection. It can also be achieved by independent injection of the outer wall and the inner wall and, if necessary, intermediate walls, then by a subsequent assembly of these parts.

Regardless of the method by which the preform is produced, when the former is intended for containers of the type of the one described in the U.S. patent application US 2015/0108077, a step for airtight attachment is implemented between an outside annular peripheral zone of the inner wall and an inside annular peripheral zone of the outer wall that is located under the neck 8, so as to constitute a seal in the area of this annular zone. In the example that is illustrated in FIG. 2, the outer wall 5 forms the outside of the body 6, the bottom 7, and a lower part of the collar 9, while the inner wall 4 forms the interior of the body 6 and that of the bottom 7, an upper part of the collar 9 and the neck 8, and the two walls are attached in an airtight way close to the collar. The neck 8, instead of being constituted on the inner wall 4, could be constituted on the outer wall 5.

According to the embodiment illustrated, which embodiment relates to the manufacturing of a container with two walls, the outer wall 5 of the preform is provided upon its manufacture with an opening 10, which is illustrated in the preform 3 in the detail inset of FIG. 2 and in the container 2 in the detail inset of FIG. 3. A propulsion gas (such as air) is intended to be injected through this opening 10 between the inner wall 4 and the outer wall 5 to deform the inner wall 4 and thus to force the product that is contained therein to exit under pressure through the neck 8. In the example illustrated, the opening 10 is made in the center of the bottom 7 of the outer wall 5 of the preform 3, in such a way as to be at the center of the bottom 12 of the outer wall 5 of the finished container 2.

The container 2 comprises a body 11, produced by deformation of the walls 4, 5 that constitute its body 6, a bottom 12 that extends to a lower end of the body 11 and is produced by deformation of the bottom 7 of the preform 3, and, at an upper end of the body 11 opposite to the bottom 12, the neck 8 and the collar 9 produced from the preform 3 and remaining unchanged during the forming of the container 2.

The forming unit 1, also called a blower, comes here in the form of a carrousel and comprises a revolving support 13, also called a wheel, and a number of molds 14, each bearing the impression of a container 2, mounted side by side on the wheel 13.

Each mold 14 can be of the portfolio type and can comprise two half-molds, namely a left half-mold 14A and a right half-mold 14B, articulated in relation to one another between a closed position in which the half-molds 14A, 14B are assembled to define jointly a cavity 15 bearing the impression of the body 11 of the container 2, and a mold bottom 16 bearing the impression of the bottom 12 of the container 2. Instead of comprising portfolio molds, the forming unit 1 could comprise molds that can move in translation in relation to one another and are therefore able to move away from or to come closer to each other, and then to be locked in the close position.

At an upper end, the mold 14 defines an opening 17 on the edge of which the preform 3 is suspended by its collar 9 during the forming of the container 2. Each mold 14 is equipped with a mechanism 18 for locking the half-molds 14A, 14B in the closed position. This mechanism 18 can have an electrical, magnetic, pneumatic, hydraulic, or else mechanical control.

As illustrated in FIGS. 2, 3, and 4, the forming unit 1 comprises, for each mold 14, a nozzle 19 that can be applied in an airtight manner against the mold 14 around the opening 17. This nozzle 19 is connected to at least one pressurized gas source 20, 21. In the example illustrated, the nozzle 19 is connected, by means of a connection 22A, to a source 20 of gas, typically air, at a so-called pre-blow-molding pressure PP, of between 5 and 20 bar, and a gas source 21 (which can also be air) at a so-called blow-molding pressure PS that is greater than the pre-blow-molding pressure PP, and typically of between 20 and 40 bar.

As is also seen in FIGS. 2, 3, and 4, the linking of the nozzle 19 to the gas sources 20, 21 can be done via a solenoid valve 23 (for example, a three-way solenoid valve).

Likewise, the nozzle 19 is connected to the outside of the forming unit 1, in other words in the open air, where an ambient pressure (denoted PA), typically the atmospheric pressure, prevails, also via a solenoid valve 24 and a connection 22B, or via a distributor, to which most often a muffler is attached. The representation given in FIGS. 2, 3, and 4 is only diagrammatic; the nozzle 19 could be connected to gas sources 20, 21 and to the outside environment (the atmosphere), not via multiple separate solenoid valves 23, 24 but via a single fluid distributor and a single connection.

Furthermore, the forming unit 1 comprises, for each mold 14, a pressure sensor 25 that is likely to measure the pressure in the nozzle 19 and therefore in the preform 3 and then the container 2 during the forming of the former. The pressure sensor 25 is, for example, mounted on the nozzle 19 and also ensures a measurement of the pressure that prevails in the area of the neck 8 of the preform 3.

The forming unit 1 comprises, finally, a computerized control unit 26, to which is connected the pressure sensor 25 from which the measurements are collected and that is programmed for controlling in particular the solenoid valves 23, 24 or the distributor and the mechanism 18 for locking each mold 14.

The forming of a container 2 is carried out as follows.

A first operation consists in loading—into the open mold 14—the preform 3, previously heated to a temperature that is higher than the glass transition temperature of the preform 3 (when the former is a single material) or to the highest of the glass transition temperatures of the different materials that compose the walls 4, 5 (when the preform 3 is of multiple materials).

A second operation consists in closing the mold 14, a third in locking it in the closed position.

Then, the nozzle 19 is brought into airtight contact with the mold 14.

FIG. 6 shows a diagram that illustrates the variations of pressure P during the forming of a normal container and a defective container, based on time T.

After bringing the nozzle 19 into airtight contact with the mold 14, a phase 100 for blow molding the preform 3 that consists in linking the interior of the preform 3 (the interior of the neck and of the inner wall) to the pressurized gas source 20, 21 (or successively the pressurized gas sources 20, 21) so as to transform it into the container 2 takes place. In the example that is illustrated in FIG. 6, the blow-molding phase comprises a pre-blow-molding step 100A, during which the interior of the preform 3 is first of all linked, via the solenoid valve 23 (or the distributor), to the gas source 20 at a pre-blow-molding pressure PP. The pre-blow-molding step 100A is followed by a blow-molding step 100B during which the preform 3 is linked, via the solenoid valve 23 (or the distributor), to the gas source 21 at the blow-molding pressure PS. It is important to remember at this stage that the pre-blow-molding step 100A is not obligatory and that the blow-molding phase 100 can consist simply in the blow-molding step 100B.

This blow-molding phase 100 can advantageously include a stretching of the preform 3, by means of a stretching rod 27 that slides into the mold 14 parallel to the main axis X. In a manner that is known in the art, the moment that the stretching begins is determined during the development of the machine, based on the characteristics of the container.

The blow-molding phase 100 is followed by a phase 200 for degassing the container 2, begun at a degassing start time Tdeg and comprising the shutdown of the blow molding and the linking of the container 2 thus formed to an environment at ambient pressure, for example atmospheric pressure (denoted PA), via the solenoid valve 24 that is controlled by the control unit 26. The environment at the ambient pressure PA is typically the local area where the forming unit 1 is installed, this local area being linked to the open air.

The degassing phase 200 can include a flushing step, which consists in linking, via openings made in the stretching rod 27, the container 2 to a gas source at a flushing pressure that is intermediate between the pre-blow-molding pressure PP and the blow-molding pressure PS. For the sake of convenience, the graph in FIG. 6 illustrates degassing with no flushing.

When the inner wall 4 of the preform 3 has no defects (i.e., fissures, cracks, or perforations), as illustrated in FIG. 3, there is no communication between the volume that is delimited by the inner wall 4 and the interface between the walls 4, 5 that remain in contact during the blow molding. In this case, the volume that is delimited by the inner wall 4 is nominal, and its complete degassing is achieved at a moment that corresponds to or is close to a theoretical moment Tth or nominal moment. In other words, the length of time of the degassing of the container 2 is very close to or equivalent to a theoretical length of time (or optimal length of time), denoted Dth, whose value verifies the following equality:

Dth=Tth−Tdeg.

In such a case, starting from the theoretical moment Tth, it is possible to open the mold without risk so as to extract the formed container therefrom.

By contrast, when the inner wall 4 is cracked, split, or else pierced, this is reflected by the appearance of a slot 28, illustrated in the detail inset of FIG. 4, which can be enlarged during forming and through which the gas that is injected into the container 2 during the blow molding sometimes may be introduced between the walls 4, 5 or between the outer wall 5 and an intermediate wall, to finish by forming a pressurized chamber 29 between them. This phenomenon is all the more accentuated with the two-walled preforms that are intended to form containers of the type that is described in the U.S. patent application US 2015/0108077 where, in a desired way so as to facilitate the emptying of the pocket formed by the inner wall 4 during the use of the container 2, the walls 4, 5 do not adhere or adhere only slightly to one another. In the case of multilayer containers, this phenomenon is more rare, but it is also possible, nevertheless, to end in the creation of a chamber between the inner wall 4 and an adjoining intermediate wall, if a delamination takes place between these two walls while the inner wall 4 becomes deteriorated.

It would be extremely dangerous, under these conditions, to open the mold at the presumed end of the degassing phase.

Actually, when a chamber 29 is formed between the inner wall 4 and the outer wall 5 or between the outer wall 5 and an adjoining intermediate wall because of the presence of a slot 28 in the inner wall 4, the inside volume that is limited by the inner wall 4 is reduced in relation to that of a container without defects. This volume is degassed therefore naturally more quickly than that of a container without defects. It is also advisable to note that the pressure that prevails in the chamber 29 accelerates the degassing of the inside volume that is limited by the inner wall 4, to the extent that this pressure tends to compress the inner wall 4 and to promote the degassing of this inside volume. The end of the degassing of the inside volume that is limited by the inner wall 4 is thus carried out at an effective moment Teff that takes place significantly more quickly than the theoretical moment Tth. This degassing is illustrated by the segment of curve in solid lines on the right of FIG. 6, beginning at the degassing start time Tdeg and ending at the effective moment Teff.

Furthermore, in such a case of manufacturing defects, during the degassing of the inside volume limited by the inner wall 4, the inner wall 4 can collapse upon itself, and even on the rod 27, under the pressure that prevails in the chamber 29, which can have the consequence of blocking the slot 28 and a locking or a significant slowing of the emptying of the chamber 29, in which a high residual pressure can exist even beyond the theoretical moment Tth.

It is advisable to note in addition that in the case of containers with two walls that have an opening 10 in the outer wall 5, the opening 10 in no way contributes to allowing the pressurized air that is contained in the chamber 29 to escape quickly from the former because its dimensions are small.

So that the pressurized air that is contained in the chamber 29 can escape quickly from the former and so that the risk is reduced and even eliminated, regardless of the type of container, it would be necessary that the slot 28 be enlarged during the blow molding until attaining dimensions such that it offers a leak flow rate toward the inner volume that is at least equivalent to the leak flow rate offered by the neck to the nozzle 19.

It is understood that the simple unlocking of the mold 14 can cause its destruction or, at the very least, damage thereto as soon as the pressurized outer wall 5 no longer encounters resistance.

So as to prevent this situation from happening, and as illustrated in FIG. 5, the forming method comprises the following operations, conducted by the control unit 26:
(300) Measurement, by means of the sensor 25, of the pressure (denoted P) that prevails in the area of the neck 8 at least during the degassing phase;
(400) Determination of the length of time that has elapsed Dec between the degassing start time Tdeg and a moment Teff1 or Teff) at which a reference pressure Pref or PA is attained in the area of the neck 8;
(500) Comparison of the length of time that has elapsed Dec with a theoretical length of time Dth starting from which the pressure in the area of the neck attains in theory the reference pressure Pref or PA;
(600) If the length of time that has elapsed Dec is greater than or equal to the theoretical length of time Dth, showing the nominal nature of the course of the degassing (cf., the segment of curve in broken lines in FIG. 6), the unlocking and the opening of the mold 14, and then the evacuation of the container 2 that is formed;
(700) If the length of time that has elapsed Dec is less than the theoretical length of time Dth, suggesting the existence of a chamber 29 between two walls, maintaining the locking of the mold.

Calculating a length of time comes down to determining the temporal difference between two moments. There are several ways to achieve this that are within the scope of one skilled in the art. By way of example, the control unit 26 can perform a calculation or a timing between two moments that it detects (that Tdeg of the degassing start and that Teff1 or Teff at which the reference pressure Pref or PA is attained).

Note that “measurement of pressure in the area of the neck” should be defined as a measurement of pressure in the environment that contains the neck 8, so that the measurement is not disrupted by a possible deformation of the inner wall 4. This measurement is advantageously carried out by the sensor 25 associated with the blow-molding nozzle 19 (which measurement proves to be easy to implement).

In the example illustrated in FIG. 6, the variations of pressure in the volume delimited by the inner wall 4 of a normal container and in the corresponding volume of a defective container are seen.

In the case of a defective container 2 (curve in solid lines during the degassing phase 200 in FIG. 6), the pressure in the volume that is delimited by the inner wall 4 decreases more quickly during the degassing phase 200 than in the case of a container 2 that is correctly formed (curve in broken lines). This faster reduction of the marker pressure constitutes a reflection of the presence of a volume that is delimited by the reduced inner wall 4 and a pressurized chamber 29 between the walls 4 and 5. It is therefore reasonable to keep the mold 14 locked, at least as long as the pressure in the entire container 2, i.e., in the inside volume and in the chamber 29, has not attained the ambient pressure PA that prevails around the manufacturing machine or a slightly higher reference pressure Pref, but at which the opening of the mold can be carried out without risk.

In an implementation of the invention, the control unit 26 determines the effective moment Teff in which the pressure in the area of the neck attains the ambient pressure PA that therefore constitutes the reference pressure. In this case, the length of time that has elapsed Dec is the length of time between the degassing start time Tdeg and the effective moment Teff (in other words, Dec=Teff−Tdeg). The length of time that has elapsed Dec is then compared to the theoretical length of time (Dth=Tth−Tdeg) that is necessary so that the pressure in the inside volume that is limited by the inner wall 4 of a container that is formed normally goes back down again to the ambient pressure PA.

In an alternative implementation, the following are predetermined, using blow-molding curves (cf. FIG. 6): on the one hand, a reference pressure Pref, of between the blow-molding pressure PS and the ambient pressure PA, and, on the other hand, a theoretical moment Tth1 with which this reference pressure Pref is able to be attained during the degassing of the inside volume that is limited by the inner wall 4 of a container that is formed normally. The control unit 26 determines the effective moment Teff1 at which the pressure in the area of the neck 8 attains this reference pressure Pref and then carries out suitable calculations and comparisons. As can be seen in FIG. 6, if the container has a defect, the effective moment Teff1 will be prior to the theoretical moment Tth1 and the length of time that has elapsed (Dec=Teff1−Tdeg) will be less than the theoretical length of time (Dth1=Tth1−Tdeg) that would be necessary so that the pressure in the inside volume that is limited by the inner wall 4 of a container that is formed normally goes back down again to the reference pressure Pref.

This implementation makes it possible to anticipate somewhat (by several fractions of seconds) the necessity of locking the mold or not.

In a variant, the reference pressure Pref is a pressure, determined in a theoretical way, starting from which it is possible to open the mold without a risk of deterioration of the latter. It can therefore be slightly higher than ambient pressure. Its value depends on the type of mold and container.

Preferably, the determination of a length of time that has elapsed Dec that is shorter than a theoretical length of time Dth or Dth1, suggesting the existence of a chamber 29 between two walls and causing locking to be maintained, is accompanied by the emergency shutdown of the forming unit 1 or of the entire production line in which this unit 1 is installed. This becomes necessary in particular when this forming unit 1 is a rotary blow-molding machine or when it is coupled to one or more other machines, such as a thermal conditioning unit (furnace) upstream and/or a filler downstream.

Also preferably, the determination of a length of time that has elapsed Dec that is less than a theoretical length of time Dth or Dth1 brings about the generation of an alert signal. The former can be visual, by being displayed on a communication interface that equips the forming unit 1 (or any other element of the production line within which the unit 1 is integrated), for example in the form of a pictogram that has a characteristic shape and/or color. The alert message can also be audible. The alert signal can also be broadcast both in visual and audible form.

Since it is not feasible to keep the mold 14 in question indefinitely locked (and the blower indefinitely shut down), the control unit 26 is advantageously programmed to delay the unlocking of this mold 14.

More specifically, the control unit 26 that is programmed for controlling:
The maintaining of the locking of the mold 14 during a predetermined length of time,
At the end of this length of time, the unlocking and the opening of the mold 14.

The opening of the mold 14 can be manual, like the evacuation of the container 2 that is presumed to be defective.

The duration of the length of time can be predetermined, for example, on the order of one minute, long enough for the degassing of the chamber 29 to be achieved with certainty. Actually, it is rare that the slot 28 is totally blocked, and there is generally a leak through the former making it possible to empty the chamber. In addition, when the container comprises an opening 10 in its outer wall 5, the former also contributes to the degassing of the chamber 29. As appropriate (in practice, depending on the volumetric capacity of the container 2), it is assumed that a length of time of greater than or equal to 30 seconds is sufficient.

It is also possible to take advantage of the presence of the opening 10 that is made in the bottom of the outer wall 5, when this opening 10 exists, so as to reduce the length of time of the locking to a minimum.

Actually, it is conceivable to provide the mold bottom 16 with a pressure sensor that can measure pressure in the opening 10. When the forming takes place normally, this pressure is the ambient pressure (typically the atmospheric pressure). In contrast, if pressurized air is introduced between the two walls, this sensor, for example connected to the control unit 26, will measure a residual pressure in the opening as long as the chamber 29 is not empty. When the pressure in the opening has returned to the ambient pressure or has attained a reference pressure (showing the end of the emptying of the chamber 29 or the attaining of an acceptable pressure), the mold can be unlocked.

Alternatively, instead of a pressure sensor, it is possible to provide a flow sensor of the gas exiting from the opening. For this purpose, the mold bottom is to be provided with a passage that makes possible an optional escape of gas through the opening. When the forming has taken place normally, no gas residue escapes during degassing and no leakage can be measured. In contrast, if the pressurized air is introduced between the two walls, this sensor, for example connected to the control unit 26, will measure a leakage at the opening as long as the chamber is not empty. When no flow is detected (showing the end of the emptying of the chamber 29), the unlocking of the mold can be brought about.

This solution can save production time by reducing the downtime of the forming unit 1 to the bare minimum with the equalization of pressures inside and outside of the container 2 that is presumed to be defective. The unlocking can be brought about since the measurement of pressure or flow rate indicates that the pressure has dropped to an acceptable value or that the emptying of the chamber 29 has been achieved.

1. Method for forming a container (2) comprising an open neck (8) by blow molding or stretch blow molding of a preform (3) with multiple walls made of plastic material, with said method comprising:
An operation for installing the preform (3) in a mold (14) bearing the impression of the container (2), with this mold (14) comprising at least two half-molds (14A, 14B) that can occupy a closed position in which the half-molds (14A, 14B) are assembled;
An operation for locking half-molds (14A, 14B) in the closed position;
A blow-molding phase that consists in linking the interior of the preform (3) to a pressurized gas source (20, 21) by means of the opening that is made in its neck (8), for a predetermined length of time, for forming the container (2), by applying at least a blow-molding pressure (PS);
A degassing phase beginning at a degassing start time (Tdeg) and consisting in the linking of the container (2) thus formed to the environment at ambient pressure (PA) so as to bring the pressure in the container back to the ambient pressure;
the method further comprising:
A continuous measurement (300) of the pressure prevailing in the area of the neck (8) during the degassing phase;
The determination (400) of the length of time that has elapsed (Dec) between the beginning of the degassing and attaining a reference pressure (Pref; PA) in the area of the neck (8);
The comparison (500) of the length of time that has elapsed with a theoretical length of time (Dth) starting from which the pressure in the area of the neck (8) in theory attains the reference pressure (Pref; PA);
Maintaining (700) the locking of the mold if the length of time that has elapsed (Dec) is less than the theoretical length of time (Dth).

2. Method according to claim 1, wherein the reference pressure (Pref) is equal to the ambient pressure (PA),
or Pref=PA.

3. Method according to claim 1, wherein the reference pressure (Pref) is between the blow-molding pressure (PS) and the ambient pressure (PA),
or PS>Pref>PA.

4. Method according to claim 3, wherein the reference pressure (Pref) is a pressure, determined in a theoretical way, starting from which it is possible to open the mold without a risk of the latter deteriorating.

5. Method according to claim 1, wherein if the length of time that has elapsed (Dec) is less than the theoretical length of time (Dth), an alert signal is generated.

6. Method according to claim 1, wherein the method is implemented in a forming unit (1), and if the length of time that has elapsed (Dec) is less than the theoretical length of time (Dth), an emergency shutdown of the forming unit (1) is brought about.

7. Method according to claim 1, further comprising, if the length of time that has elapsed (Dec) is less than the theoretical length of time (Dth):
The maintaining of the locking of the mold (14) during a predetermined length of time,
At the end of the length of time, the unlocking and the opening of the mold (14).

8. Method according to claim 7, wherein the length of time is greater than or equal to 30 seconds.

9. Method according to claim 8, wherein the length of time is approximately one minute.

10. Method according to claim 1, wherein the container comprising an inner wall and an outer wall, with the latter being provided with an opening (10) for linking to the outside, if the length of time that has elapsed (Dec) is less than the theoretical length of time (Dth), the pressure at the opening is measured, and when the pressure at the opening attains the reference pressure (PA; Pref), an unlocking of the mold is brought about.

11. Method according to claim 1, wherein the container comprising an inner wall and an outer wall, with the latter being provided with an opening for linking to the outside, if the length of time that has elapsed (Dec) is less than the theoretical length of time (Dth), the flow rate of the gas that exits from the opening is measured, and when this flow rate becomes zero, an unlocking of the mold is brought about.

12. Method according to claim 2, wherein if the length of time that has elapsed (Dec) is less than the theoretical length of time (Dth), an alert signal is generated.

13. Method according to claim 3, wherein if the length of time that has elapsed (Dec) is less than the theoretical length of time (Dth), an alert signal is generated.

14. Method according to claim 4, wherein if the length of time that has elapsed (Dec) is less than the theoretical length of time (Dth), an alert signal is generated.

15. Method according to claim 2, wherein the method is implemented in a forming unit (1), and if the length of time that has elapsed (Dec) is less than the theoretical length of time (Dth), an emergency shutdown of the forming unit (1) is brought about.

16. Method according to claim 3, wherein the method is implemented in a forming unit (1), and if the length of time that has elapsed (Dec) is less than the theoretical length of time (Dth), an emergency shutdown of the forming unit (1) is brought about.

17. Method according to claim 4, wherein the method is implemented in a forming unit (1), and if the length of time that has elapsed (Dec) is less than the theoretical length of time (Dth), an emergency shutdown of the forming unit (1) is brought about.

18. Method according to claim 5, wherein the method is implemented in a forming unit (1), and if the length of time that has elapsed (Dec) is less than the theoretical length of time (Dth), an emergency shutdown of the forming unit (1) is brought about.

19. Method according to claim 2, further comprising, if the length of time that has elapsed (Dec) is less than the theoretical length of time (Dth):
The maintaining of the locking of the mold (14) during a predetermined length of time,
At the end of the length of time, the unlocking and the opening of the mold (14).

20. Method according to claim 3, further comprising, if the length of time that has elapsed (Dec) is less than the theoretical length of time (Dth):
The maintaining of the locking of the mold (14) during a predetermined length of time,
At the end of the length of time, the unlocking and the opening of the mold (14).
